(19) United States
(12) Patent Application Publication
(10) Pub. No.: US 2004/0143656 A1
(43) Pub. Date: Jul. 22, 2004

(54) Control software architecture for realizing a decentralized cooperative control of a plurality of electronic control apparatuses connected via a network

(75) Inventors: Minoru Okada, Anjo-shi (JP); Masahiro Goto, Okazaki-shi (JP); Akihito Iwai, Chiryu-shi (JP); Toshiki Matsumoto, Kariya-shi (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/752,554

(22) Filed: Jan. 8, 2004

(30) Foreign Application Priority Data
Jan. 15, 2003 (JP) 2003-6976

(51) Int. Cl. G06F 15/173

(52) U.S. Cl. 709/223

(57) ABSTRACT

In control software architecture for realizing a decentralized cooperative control of a plurality of electronic control apparatuses being connected via a network, control application software for realizing the control of each system has no data management function and no time synchronization function. Instead, the data management function and the time synchronization function are allocated in a decentralized control application framework which is commonly used for the electronic control apparatuses.

### BACKGROUND OF THE INVENTION

The present invention relates to control software architecture and control apparatuses employing this control software architecture which can improve reusability of control application software.

Conventionally, according to the decentralized cooperative control performed through a network, it is known that the time synchronization processing among respective systems connected via the network, or between control application softwares and communication softwares, and the position information processing of respective control application softwares, as well as the execution order management of the control application softwares are explicitly executed in the control application softwares (For example, refer to EP658257B1).

In such cases, for example, the vehicle cooperative decentralized control dose not explicitly separates control request instruction data and in-vehicle/out-vehicle condition common data from communications specifications definitions and from ECU software packaging configuration. Accordingly, the data having the same meaning are defined multiple times in the communications specifications definitions. As a result, the communications specifications definitions become very redundant. The load of communications increases greatly. Furthermore, according to the ECU software packaging configuration, the data common to both the control request instruction data and the in-vehicle/out-vehicle condition are not separated. When it is required to relocate respective functions of the vehicle control to other ECU according to the vehicle type, there is the possibility that the processing order may be forcibly changed according to the request timing from other ECU or according to the status of a communication bus. Its result may give adverse influence to the control of function or/and the overall control of the system.

To avoid such situations, it is necessary to redesign the management information with respect to the execution order of controls for respective control applications when the functions of the vehicle controls are relocated, so that each control application can execute the order management appropriately.

In other words, when each control application performs the order management, in a case that the function is relocated to other ECU according to the vehicle type, it is necessary to redesign the order management or the like every time for each of the control applications. In this respect, the reusability of softwares worsened recently.

### SUMMARY OF THE INVENTION

In view of the above-described problems, the present invention has an object to provide control software architecture and control apparatuses embodying this architecture which can improve the reusability of control application softwares even when relocation of functions is performed among a plurality of ECUs.

In order to accomplish the above and other related objects, the present invention provides a first control software architecture for realizing a decentralized cooperative control of a plurality of electronic control apparatuses connected via a network. According to the first control software architecture, no data management function and no time synchronization function are involved in each control application software which is prepared in each electronic control apparatus to realize each system, and the data management function and the time synchronization function are allocated in a subordinate decentralized control platform of each control application software, so as to be commonly used for the plurality of electronic control apparatuses.

According to the prior art techniques, the control application software realizing each control system has data management function and time synchronization function, such as exchange of the data and operation or calculation timing, which are used for executing the system. Hence, when a certain portion of control application software is modified in the control architecture for realizing related control of a plurality of systems being connected via a network, it is necessary to redesign all of the application softwares. On the other hand, according to the first control software architecture of this invention, both the data management function and the time synchronization function are separated from the control application software. Instead, the data management function and the time synchronization function are allocated in the subordinate decentralized control platform located close to the network. Therefore, in a case that specific or arbitrary control application software is modified, all necessary to do is to redesign only the decentralized control platform. In other words, this invention improves the reusability of other control application softwares.

Furthermore, the present invention provides a second control software architecture for realizing a decentralized cooperative control of a first electronic control apparatus and a second electronic control apparatus connected via a network. According to the second control software architecture, the first electronic control apparatus includes at least one control application software realizing at least one system but having no data management function, a decentralized control platform having a data management function, and driver software receiving an actuator drive command instructed from the control application software via the decentralized control platform or/and transmitting data to the decentralized control platform. The second electronic control apparatus includes at least one control application software realizing at least one system but having no data management function, a decentralized control platform having a data management function, and driver software receiving an actuator drive command instructed from the control application software via the decentralized control platform or/and transmitting data to the decentralized control platform. And, the decentralized control platform provided in the first electronic control apparatus and the decentralized control platform provided in the second electronic control apparatus are commonized with each other.

According to this arrangement, the same decentralized control platform is provided in the first and second electronic control apparatuses. For example, compared with a case that the decentralized control platform is provided in only the first electronic control apparatus, it becomes possible to reduce the load of processing necessary in obtaining the data via the network from respective electronic control apparatuses. Hence, in addition to the reusability of control application softwares described in the first control software architecture, the second control software architecture brings the effect of suppressing the delay in response.

Furthermore, the present invention provides a third control software architecture for realizing a decentralized cooperative control of a plurality of electronic control apparatuses connected via a network. According to the third control software architecture, each electronic control apparatus includes control application software realizing each system but having no data management function, a decentralized control platform having a data management function, and driver software. The decentralized control platform includes, as means common to respective electronic control apparatuses, a data queue temporarily memorizing request instruction data for realizing the system and a condition common data section temporarily memorizing condition data used in executing the system.

According to this arrangement, the decentralized control platform has the capability of managing the request instruction data and the condition data used in the control application software. Each one of control application softwares is released from the data management function. The reusability of control application softwares can be improved.

The present invention provides a fourth control software architecture and for realizing a decentralized cooperative control of a plurality of electronic control apparatuses connected via a network. According to the fourth control software architecture, each of the electronic control apparatuses includes control application software realizing each system and having no time synchronization function, a decentralized control platform provided commonly for the plurality of electronic control apparatuses and having time synchronization function for communications softwares for executing communications between respective systems, between respective control application softwares, and between respective electronic control apparatuses, and driver software receiving an actuator drive command instructed from the control application software via the decentralized control platform or/and transmitting data to the decentralized control platform.

In a system constituted by a plurality of electronic control apparatuses connected via a network, it is necessary to assure time synchronization of operation processing timing in the control application software in each system or the data used in operation to avoid any trouble occurring in the control. In this respect, the present invention allocates the time synchronization function to the decentralized control platform, not to the control application software. Thus, even when one or more control application softwares are exchanged, other control application softwares can be used without redesigning.

Preferably, the condition data are renewed together in each electronic control apparatus. For example, the condition data supplied from the driver software to the control application software may be transmitted or received with temporal differences. In this case, the operation in the control application software is executed based on the condition data having no consistency in the time being obtained. However, simultaneously renewing all of the condition data in each electronic control apparatus can assure accuracy or/and consistency of the operation result in the control application software of each electronic control apparatus.

Preferably, each of the request instruction data is assigned a priority beforehand. For example, when a plurality of electronic control apparatuses occasionally transmit request instruction data from their control application softwares to a data queue, it will be necessary for this data queue to determine the order of transmitting the received request instruction data to related control application softwares requiring these data. In this case, assigning the priority to each request instruction data beforehand makes it possible to eliminate the mediation among the received request instruction data.

Preferably, all of the request instruction data transmitted from each electronic control apparatus or from each control application software or/and all of the request instruction data received by each control application software are exchanged via the data queue of the decentralized control platform. With this arrangement, even when the control application software is modified according to the vehicle type, all necessary to do is to determine the processing order of each modified request instruction data with reference to the priority of the request instruction data of unmodified control application softwares. The number of man-hour required in the designing stage can be decreased.

Preferably, the decentralized control platform is provided with position information identifying an ECU in which the control application software is located. For example, when a plurality of electronic control apparatuses exchange the requests of respective control application softwares, it may be possible that each electronic control apparatus has the information identifying an electronic control apparatus in which the designated control application software is present. However, in this case, if a part of the electronic control apparatuses connected via a network is changed or according to the vehicle type, or/and when a part of the control application software is changed, it will be necessary to rewrite all of the position information of the electronic control apparatuses or/and control application softwares being not exchanged. However, according to this invention, it is only necessary to rewrite the decentralized control application software common to respective electronic control apparatuses or common to respective control application softwares. Thus, redesigning work can be done at a time.

Preferably, time synchronization function is for transmitting the data with reference to a transmission timing determined according to a deadline time of the processing in the control application software, thereby realizing optimum time synchronization in each electronic control apparatus.

In general, an electronic control apparatus has a scheduling function, i.e., a function of managing the order of activation or/and operation timings of respective control application softwares. However, this is not sufficient because a problem may arise when other control application software starts its operation before the operation of one control application software is not finished yet. More specifically, if other operation starts at the timing the processing to be accomplished beforehand is not finished yet, the processing may be executed based on the old data used in the previous operation. The consistency of the data will be lost, in this case. However, according to this invention, the transmission timing is determined based on the deadline time. Hence, the consistency of the data can be assured. In other words, according to this invention, the function for assuring the consistency of the data among control application softwares and/or among electronic control apparatuses is allocated to the decentralized control platform, not to each of the control application softwares. The time synchronization function of this invention can be construed as a function of assuring the consistency of the above-described data.

Preferably, the condition common data section and the data queue are provided for each one of the control application softwares, and the data queue includes a request acceptance data queue for receiving the request instruction data from other control application software and a request issue data queue for issuing the request instruction data to other control application software. In managing the request instruction data produced in each control application software, discriminating between the request instruction data issued from its own control application software and the request instruction data originated from other control application software is effective to simplify the design of the decentralized control platform.

Preferably, the decentralized control platform is equipped for each one of the control application softwares.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a schematic diagram showing an overall arrangement of a preferred embodiment of the present invention;

FIG. 2 is a schematic diagram chiefly showing the arrangement of decentralized control application frameworks shown in FIG. 1;

FIG. 3 is a diagram showing a detailed control software architecture embodying the contents of FIGS. 1 and 2, and control apparatuses using this software architecture;

FIG. 4 is a table showing data transmitting/receiving conditions in respective ECUs shown in FIG. 3 and priorities assigned to respective control request commands; and

FIG. 5 is a timing chart explaining the function of a decentralized control platform for realizing optimum time synchronization among respective ECUs.

### DESCRIPTION OF THE PREFERRED EMBODIMENT

A preferred embodiment of the present invention will be explained hereinafter with reference to attached drawings.

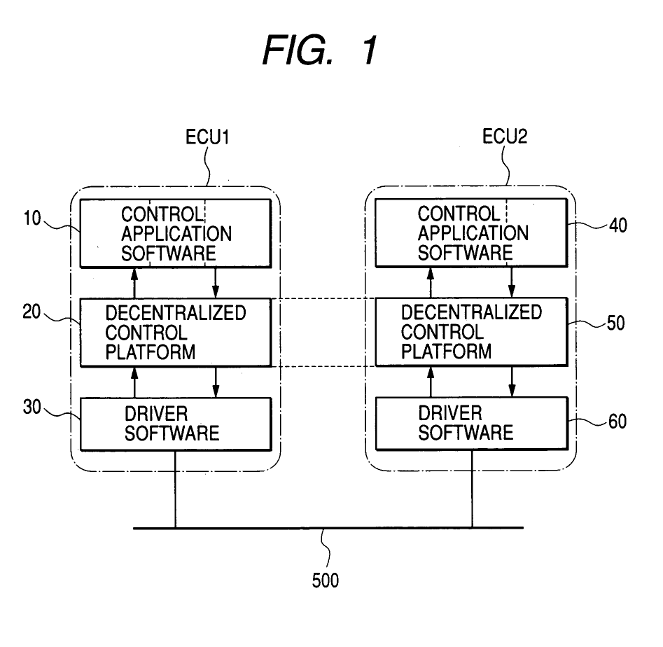

FIG. 1 is a schematic diagram showing an overall arrangement of a preferred embodiment of the present invention.

A first ECU (hereinafter, also referred to as electronic control apparatus) 1 and a second ECU 2 are connected via a network 500. The first ECU 1 includes control application software 10, a decentralized control platform 20, and driver software 30. Similarly, the second ECU 2 includes control application software 40, a decentralized control platform 50, and driver software 60.

Each of the control application softwares 10 and 40 is for realizing one or a plurality of systems. For example, the systems realized by these control application softwares involve various vehicle control devices or equipments, such as an antiskid control system, a traction control system, a vehicle behavior stabilizing system, a braking assist system, and an engine control system. When one ECU includes a plurality of systems, this ECU includes a plurality of control application softwares.

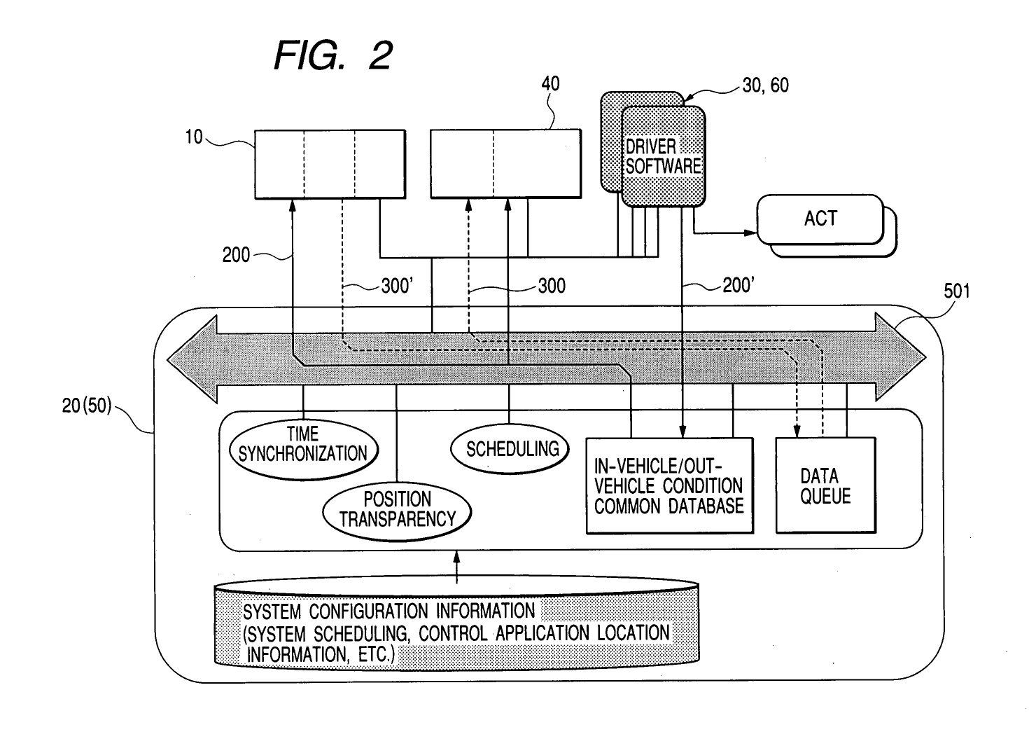

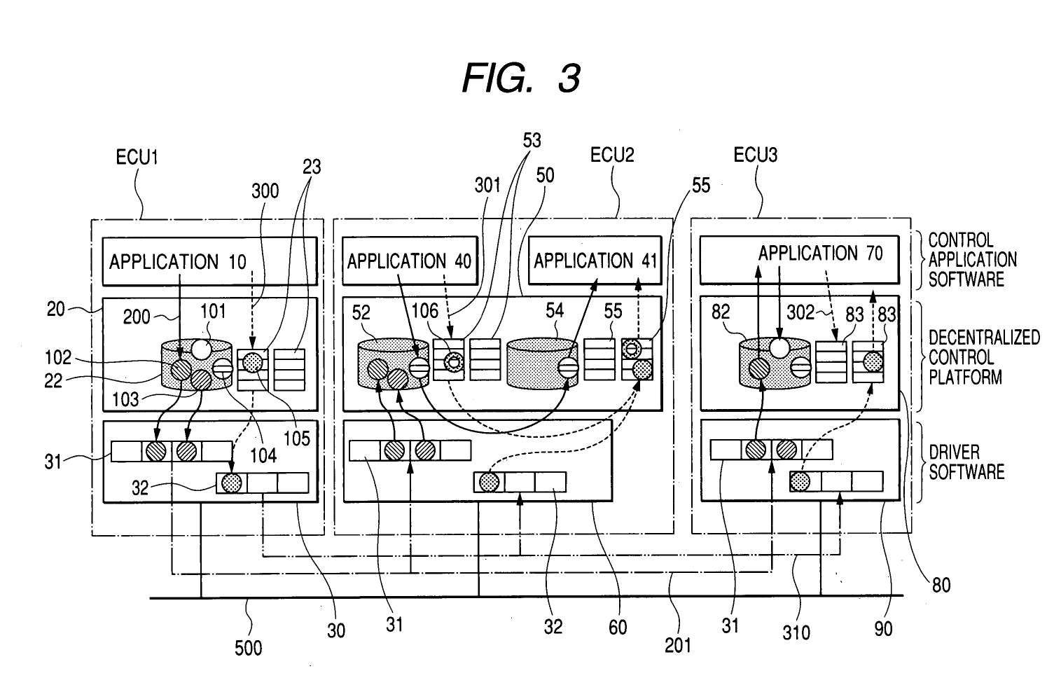

The decentralized control platforms 20 and 50, as later-described with reference to FIGS. 2 and 3, have the same architecture common to respective ECUs which includes, as internal arrangement, an in-vehicle/out-vehicle condition common database, a data queue, and others. The decentralized control platforms 20 and 50 have a scheduling function for regulating or managing activation or hierarchy of operations among respective ECUs or/and respective control application softwares, and also have a function of securing position transparency based on location information indicating an ECU in which the control application software is located. Furthermore, the decentralized control platforms 20 and 50 have a function of realizing time synchronization among respective control application softwares or/and electronic control apparatuses together with the order management by the scheduling.

Each of the driver softwares 30 and 60 receives a command sent from the associated control application software via the decentralized control application framework, and drives an actuator (ACT), although not shown, which depends on this control application software. The driver softwares 30 and 60 receive detected information obtained by respective actuators, and transmit the detected information to the in-vehicle/out-vehicle condition common database of the decentralized control application framework.

FIG. 2 is a schematic diagram chiefly showing the arrangement of the decentralized control platforms 20 and 50 shown in FIG. 1. The decentralized control platforms provided in respective ECUs are similar in architecture. In other words, this arrangement is substantially equivalent to a single decentralized control platform provided commonly for respective ECUs.

As the decentralized control platforms 20 and 50 in respective ECUs 1 and 2 are similar in architecture, these decentralized control platforms 20 and 50 can be regarded as single software. The decentralized control platform 20 (50) has an in-vehicle/out-vehicle condition common database common for the control application softwares 10 and 40 of respective ECUs 1 and 2. The control application softwares 10 and 40 receive condition data from the in-vehicle/out-vehicle condition common database, as indicated by a solid arrow 200. The request instruction data for requesting the execution of the system produced by the control application software 10 is once supplied to a data queue of the decentralized control platform 20 (50) from the control application software 10 via a software bus 501 as indicated by a dotted arrow 300′. Then, the request instruction data is transmitted to the control application software 40 via the software bus 501 as indicated by a dotted arrow 300. Furthermore, the condition data obtained from respective actuators are transmitted from respective driver softwares 30 and 60 to the in-vehicle/out-vehicle condition database as indicated by a solid arrow 200′, and are renewed. The renewal of the condition data is executed at a time commonly for respective in-vehicle/out-vehicle condition common databases in the decentralized control application frameworks of all ECUs.

The decentralized control platform 20 (50) includes system configuration information, such as system scheduling and control application location information. The system scheduling is the execution order, such as operation or calculation timings and activation timings, among respective ECUs or/and respective control applications. Furthermore, the control application location information is the position information indicating an ECU in which the control application is located. The architecture of the decentralized control platforms 20 and 50 of respective ECUs is common in the function for realizing the previously-described time synchronization, in the function relating to position transparency, and in the function relating to scheduling, as well as in having the in-vehicle/out-vehicle condition common database and the data queue.

When a combination of the in-vehicle/out-vehicle condition database and the data queue is exclusively provided for each one of control application softwares, the number of the in-vehicle/out-vehicle condition common databases and the data queues provided in the decentralized control platforms of respective ECUs is variable depending on the number of the control application softwares provided in a single ECU. However, even in such a case, the architecture of the decentralized control platforms 20 and 50 of respective ECUs can be construed as identical.

It is possible to provide the combination of the in-vehicle/out-vehicle condition common database and the data queue exclusively for each one of the control application softwares, or alternatively, for each one of ECUs. It is also possible to locate the in-vehicle/out-vehicle condition common database and the data queue depending on the characteristics of condition data transferred via the in-vehicle/out-vehicle condition common database and the characteristics of request instruction data transferred via the data queue. For example, it is possible to make a group of condition data or/and request instruction data having properties to be processed together under the identical time management. In this case, the in-vehicle/out-vehicle condition common database and/or the data queue commonly used for the group can be provided in each ECU. In this case, there is the possibility that the in-vehicle/out-vehicle condition common database and/or the data queue are not provided for each one of control application softwares.

FIG. 3 is a diagram showing a detailed control software architecture embodying the contents of FIGS. 1 and 2, and control apparatuses using this software architecture. The arrangement shown in FIG. 3 is different from those shown in FIGS. 1 and 2 in that a total of three ECUs are provided.

The decentralized control platform 20 of the first ECU 1 includes an in-vehicle/out-vehicle condition common database 22 and a data queue 23. The decentralized control platform 50 of the second ECU 2 includes two in-vehicle/out-vehicle condition common databases 52 and 54 and two data queues 53 and 55. A set of the in-vehicle/out-vehicle common database 52 and the data queue 53 is dedicated to control application software 40. Another set of the in-vehicle/out-vehicle condition common database 54 and the data queue 55 is dedicated to control application software 41. In other words, the combination of an in-vehicle/out-vehicle condition common database and a data queue is provided for each one of control application softwares. Similarly, a third ECU 3 has a decentralized control platform 80 including an in-vehicle/out-vehicle condition common database 82 and a data queue 83 which are dedicated to control application software 70.

The in-vehicle/out-vehicle condition common databases 22, 52, 54, and 82 provided in the decentralized control platforms 20, 50, and 80 of respective ECUs 1 to 3 receive the same condition data transmitted from respective actuators via the driver softwares. These condition data are stored and renewed as common condition data.

More specifically, condition data 101 to 104 are condition data required in the systems realized by the control application softwares 10, 40, 41, and 70. For example, practical condition data used in the vehicle controls are a vehicle traveling speed, a wheel rotation speed, an engine speed, a fuel injection amount, a vehicle acceleration, and the like. These condition data are the ones necessary at least one of the systems and, even when required in a plurality of systems, are preferably the univocal value. For example, an automotive vehicle is equipped with a vehicle behavior stabilizing system, an engine control system, and an antiskid control system. In this case, the vehicle traveling speed serves as common condition data for all of these systems. On the other hand, the wheel rotation speed, the engine speed, the fuel injection amount, the vehicle acceleration and the like should be also the common condition data of respective systems.

The data queues 23, 53, 55, and 83 have the capability of temporarily memorizing request instruction data for executing the system in the exchange of control application softwares. More specifically, in the case that the control application softwares directly exchange the request instruction data, it is difficult for each one of the control application softwares to determine the order of the received request instruction data because the control application software itself has no capability of determining the order of data. Hence, the capability of determining the order of the request instruction data is allocated to the decentralized platform in which the priority is determined by the data queue temporarily storing the data.

Namely, each request instruction data itself is assigned the priority beforehand in all of the application softwares connected to each other via the network. The data queue determines the order according to the priority. For example, a torque request instruction is a practical request instruction data used in the vehicle controls. More specifically, in the engine control system, the torque request instruction is an engine drive torque (or axle drive torque). In the antiskid control system, the torque request instruction is a braking torque applied to a wheel. In this manner, it is possible to designate a request instruction value as request instruction data when this request instruction value is for executing the control having the dimensions common to respective systems. On the other hand, the request instruction data can be a request instruction value independently given to each system. Furthermore, it is possible that the request instruction data include both the above-described request instruction values common to respective systems and the request instruction values peculiar to respective systems.

Each of the data queues 23, 53, 55, and 83 includes an acceptance data queue for receiving request instruction data from a corresponding control application software and an issue data queue for issuing request instruction data supplied to a designated control application software. As described previously, each acceptance data queue executes the acceptance with reference to the priority being pre-assigned to the request instruction data. Similarly, each issue data queue transmits the control request instruction with reference to this priority.

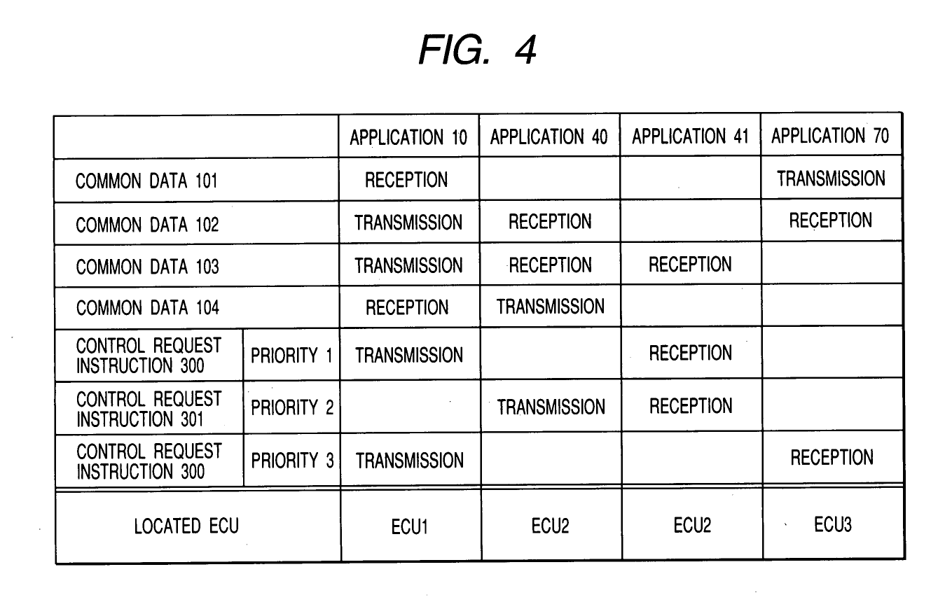

Next, the flow of condition data 101 to 104 exchanged among respective control application softwares via the decentralized control platform and the driver software and the flow of request instruction data 105 used in executing the system will be explained with reference to FIGS. 3 and 4.

As shown in the table of FIG. 4, according to this embodiment, control request instructions supplied from respective control application softwares 10, 40, and 70 are assigned the priority. More specifically, the control request instruction supplied from the control application software 10 (indicated by a dotted arrow 300) has the first priority. The control request instruction supplied from the control application software 40 (indicated by a dotted arrow 301) has the second priority. The control request instruction supplied from the control application software 70 (indicated by a dotted arrow 302) has the third priority. According to this embodiment, the control application software 41 only receives the control request instruction supplied from other control application software. Hence, no control request instruction is produced from this control application software 41.

First, the flow of condition data 101 to 104 will be explained hereinafter. Among various flows of respective condition data, the flow of condition data in each ECU is indicated by a solid line 200. The flow of condition data among respective ECUs via the network 500 is indicated by an alternate long and short dash line 201.

Among the condition data 101 to 104, three condition data 101, 103, and 104 are detection values periodically obtained from respective actuators via the network 500 and the driver softwares 30, 60, and 90. The condition data 101, 103, and 104 are stored and renewed as common values in respective in-vehicle/out-vehicle condition common databases 22, 52, 54, and 82. On the other hand, the remaining condition data 102 represents the condition of a value processed in the control application software 10 and memorized in the in-vehicle/out-vehicle condition common database 22.

First, among these condition data 101 to 104, the condition data 102 and 103 are transmitted to a message frame 31 of the driver software 30. Then, this message frame 31 is transmitted via the network 500 to the driver software 60 of the second ECU 2 and to the driver software 90 of the third ECU 3, simultaneously. Then, the driver software 60 and the driver software 90 simultaneously send necessary condition data involved in this message frame 31 to the in-vehicle/out-vehicle condition common database 52 and the in-vehicle/out-vehicle condition common database 82, respectively. More specifically, in the second ECU 2, the condition data 102 and the condition data 103 supplied from the message frame 31 are stored into the in-vehicle/out-vehicle condition common database 52. In the third ECU 3, only the condition data 102 among the condition data involved in the message frame 31 is stored into the in-vehicle/out-vehicle condition common database 82. 1 this manner, each ECU chooses necessary condition data and manages the timing of transmitting the condition data. In this case, only the condition data required for each control application software installed in this ECU is managed by each ECU or each control application software manages. The condition data 103 stored in the in-vehicle/out-vehicle condition common database 22 is identical with those stored in the in-vehicle/out-vehicle condition common databases 52, 54, and 82. The condition data 103 can be mounted on the message frame 31 or may not be mounted. However, it will be necessary to be mounted on the message frame in the case that the control application software 10 instructs the control application softwares 40 and 70 to use the condition data 102 and 103 among a plurality of condition data at the next operation or calculation timing. In this case, it will be difficulty in assuring consistency with respect to time synchronization in exchanging the condition data among respective in-vehicle/out-vehicle condition common databases, if each in-vehicle/out-vehicle condition common database is installed and managed exclusively for each ECU or for each one of control application softwares. To solve this problem, the time synchronization function is allocated to the decentralized platform which is commonly used for all ECUs.

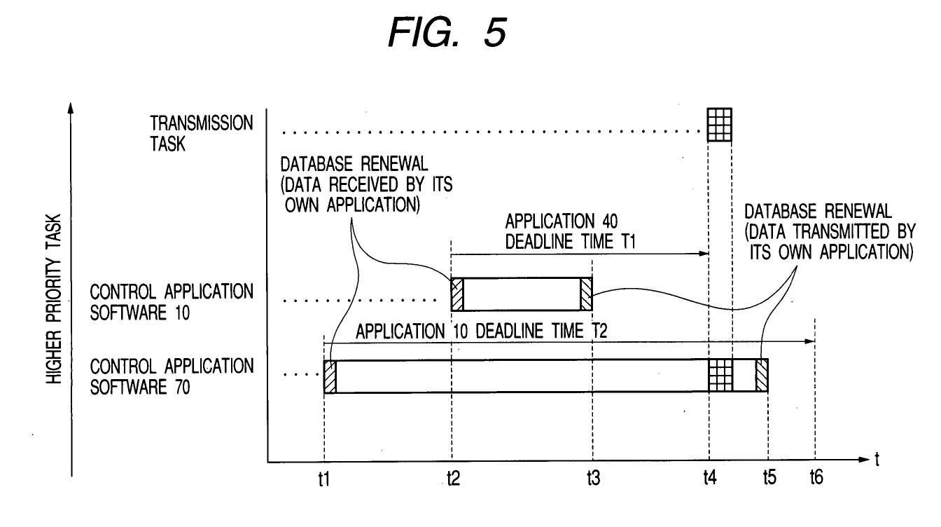

FIG. 5 is a timing chart explaining the function of the decentralized control platform for realizing optimum time synchronization among a plurality of ECUs. The above-described problem of time synchronization will be similarly raised in a later-described control request instruction.

Next, the condition data, corresponding to condition data 104 being processed beforehand in the control application software 40, is transmitted from the control application software 40 to the in-vehicle/out-vehicle condition common database 52. Then, the condition data 104 is transmitted from the in-vehicle/out-vehicle condition common database 52 to the in-vehicle/out-vehicle condition common database 54 corresponding to the control application software 41, and is subsequently transmitted to the control application software 41.

Next, the condition data 102 is transmitted from the in-vehicle/out-vehicle condition common database 82 to the control application software 70. Then, the condition data, corresponding to condition data 101 being processed beforehand in the control application software 70, is transmitted from the control application software 70 to the in-vehicle/out-vehicle condition common database 82.

Next, the flow of the control request instructions will be explained hereinafter. The flow of control request instruction in each ECU is indicated by dotted lines 300 and 301. The flow of control request instructions among respective ECUs via the network 500 is indicated by an alternate long and short dash line 310. The control request instruction 300 is for transmitting the request instruction data 105 from the control application software 10 to the data queue 23. This control request instruction is transmitted to a message frame 32 of driver software 30 and to the driver software 60 of second ECU 2 via the network 500. Then, this control request instruction is transmitted from the driver software 60 to the data queue 55 corresponding to the control application software 41.

Next, the control application software 40 transmits the control request instruction 301 involving request instruction data 106 to the data queue 53. As the request instruction data 106 is used in the control application software 41, the request instruction data 106 is transmitted to the data queue 55. Then, the request instruction data 106 is transmitted from the data queue 55 to the control application software 41.

Next, the request instruction data 105 stored in the data queue 83 of ECU 3 is transmitted to control application software 70.

FIG. 5 explains the assurance with respect to time synchronization among respective ECUs and/or among control application softwares. To simplify the explanation, FIG. 5 only uses two control application softwares 10 and 40. The similar disclosure and explanation will be used for three or more control application softwares.

As shown in FIG. 5, deadline times T1 and T2 are defined so that respective control application softwares 10 and 40 surely terminate or accomplish the required processing in respective control application softwares. In general, these deadline times T1 and T2 are statistically determined according to the contents of processing executed in each control application software. The operations or calculations result being processing within these deadline times is transmitted as a message in accordance with a transmission task. Each control application software is periodically activated (e.g., every 6 ms), or, in other words, starts operations or calculations at predetermined intervals. Thus, defining an independent deadline time for each control application software makes it possible to execute periodical transmission by transmission task.

Furthermore, the calculation result at other nodes or the like is received during the processing of the control application software and the in-vehicle/out-vehicle condition common database is renewed. To give no adverse influence to the processing of each control application software, it is preferable to limit the activation and/or termination timing for each application software. Furthermore, it is preferable to simultaneously renew the condition data in respective in-vehicle/out-vehicle condition common databases 22, 52, 54, and 82 at a time. In this manner, the time synchronization among a plurality of systems is done based on the deadline time of each control application software, so as to realize reliable time synchronization by system scheduling. Furthermore, allocating or giving such time synchronization function to the decentralized control platform makes it possible to stably execute the cooperative control among a plurality of systems without being influenced by processing load change in respective control application softwares, or by temporal variation brought by external factors such as interrupt processing or high-priority task processing. The time synchronization function is a function of assuring the consistency of the data exchanged among a plurality of control application softwares or/and electronic control apparatuses which mutually require the consistency in their operations. Namely, realizing the time synchronization is to assure the consistency of the data. Although the consistency of the data and the time synchronization function will be explained with reference to FIG. 5, the meaning of them can be expressed in brief as a function of preventing the data resulting from different operation timings from being mixed unwantedly. For example, the data resulting from the (n-*)^{th} operation (or receiving) timing should be discriminated or separated from the data resulting from the n^{th} operation (or receiving) timing, in a case that respective application softwares in the control application software are different from each other in the operation or calculation timing, or in a case that detection results of respective sensors transmitted to respective electronic control apparatuses are different from each other in receiving timing or operation or calculation timing, or in a case that there is a significant difference between the internal timers equipped in respective electronic control apparatuses.

At the time t1, execution of the processing in the control application software 70 is started. First, the condition data 102 of its own in-vehicle/out-vehicle condition common database 82 is renewed and the request instruction data 106 of the data queue 83 is also renewed. More specifically, the third ECU3 requests the first ECU 1 to transmit newest values of the condition data 102 and the request instruction data 106. Then, the processing of control application software 10 is started at the time t2 during the execution of the processing in the control application software 70. The control application software 10 has a priority higher than that of the control application software 70. The deadline time of the processing of this control application software 10 is set to time T1 starting from t2. In the beginning of the processing of control application software 10, its own in-vehicle/out-vehicle condition common database 22 is renewed and the request instruction data in the data queue 23 is also renewed. Then, the processing in the control application software 10 surely terminates at the time t3 earlier than the time t4 designated by the deadline time T1. At the time t4, in response to a transmission task, transmission to the third ECU3 is executed. In this case, at the end of the processing, the condition data and the request instruction data being processed in the control application software 10 are transmitted to the in-vehicle/out-vehicle condition common database 22 and the data queue 23, respectively.

Meanwhile, the processing in subordinate control application software 70 terminates at the time t5 earlier than the time t6 designated by the deadline time T2 starting from the beginning of the processing. At the end of the processing, the condition data being processed in the control application software 70 is transmitted to the in-vehicle/out-vehicle condition common database 82.

This invention is not limited to the above-described embodiment and can be variously modified.

For example, according to the above-described embodiment, the transmission and renewal of the condition data in the in-vehicle/out-vehicle condition common databases 22, 52, 54, and 82 being executed via respective driver softwares are simultaneous to assure the time synchronization. However, there may be a possibility that data renewal during the processing in certain control application software causes a trouble in the system. In this case, it is preferable to bring this condition data into a pending or waiting condition for a while and then transmit and renew this condition data at the activation or/and termination timing of this control application software.

For example, the condition data may be used in the processing of the control application software. In this case, if the condition data is renewed during the operation processing, it will be difficult to maintain adequate time synchronization between the renewed condition data and the original data. In such a case, the system will be brought into trouble as a result of the data renewal executed during the processing of the control application software. Such situations are predictable beforehand in the designing stage of the control software architecture. Accordingly, it is desirable to set the priority for them in the renewal and transmission of the condition data.

Furthermore, the second ECU 2 shown in FIG. 3 includes a plurality of control application softwares. It is possible to provide the location information of these control application softwares in the decentralized control platform of the decentralized control application framework. Based on this location information, when there is any control application software in the same ECU to which the request instruction data or the condition data is transmitted, it is possible to directly renew the in-vehicle/out-vehicle condition common database of the opponent control application software without using the network. Or, it is possible to directly register the request instruction data to the opponent data queue. Needless to say, it is possible to use the network instead of executing the above-described direct renewal and registration.

What is claimed is:

1. A control software architecture for realizing a decentralized cooperative control of a plurality of electronic control apparatuses connected via a network, wherein
no data management function and no time synchronization function are involved in each control application software which is prepared in each electronic control apparatus to realize each system, and
data management function and time synchronization function are allocated in a subordinate decentralized control platform of said each control application software, so as to be commonly used for said plurality of electronic control apparatuses.

2. The control software architecture in accordance with claim 1, wherein said decentralized control platform is provided with position information identifying an ECU in which said control application software is located.

3. The control software architecture in accordance with claim 1, wherein said time synchronization function is for transmitting the data with reference to a transmission timing determined according to a deadline time of the processing in said control application software, thereby realizing optimum time synchronization in each electronic control apparatus.

4. The control software architecture in accordance with claim 1, wherein said decentralized control platform is equipped for each one of said control application softwares.

5. A control software architecture for realizing a decentralized cooperative control of a first electronic control apparatus and a second electronic control apparatus connected via a network, wherein
said first electronic control apparatus comprises:
at least one control application software for realizing at least one system, said control application software having no data management function;
a decentralized control platform having a data management function; and
driver software for receiving an actuator drive command instructed from said control application software via said decentralized control platform or/and for transmitting data to said decentralized control platform,
said second electronic control apparatus comprises:
at least one control application software for realizing at least one system, said control application software having no data management function;
a decentralized control platform having a data management function; and
driver software for receiving an actuator drive command instructed from said control application software via said decentralized control platform or/and for transmitting data to said decentralized control platform,
wherein said decentralized control platform provided in said first electronic control apparatus and said decentralized control platform provided in said second electronic control apparatus (2) are commonized with each other.

6. The control software architecture in accordance with claim 5, wherein said decentralized control platform is provided with position information identifying an ECU in which said control application software is located.

7. The control software architecture in accordance with claim 5, wherein said decentralized control platform is equipped for each one of said control application softwares.

8. A control software architecture for realizing a decentralized cooperative control of a plurality of electronic control apparatuses connected via a network, wherein
each of said electronic control apparatuses comprises:
control application software for realizing each system, said control application software having no data management function;
a decentralized control platform having a data management function; and
driver software,
wherein said decentralized control platform comprises, as means common to respective electronic control apparatuses:
a data queue for temporarily memorizing request instruction data for realizing said system; and
a condition common data section for temporarily memorizing condition data used in executing said system.

9. The control software architecture in accordance with claim 8, wherein said condition data are renewed together in said each electronic control apparatus.

10. The control software architecture in accordance with claim 9, wherein each of said request instruction data is assigned a priority beforehand.

11. The control software architecture in accordance with claim 9, wherein
all of said request instruction data transmitted from said each electronic control apparatus or from said each control application software or/and all of said request instruction data received by said each control application software are exchanged via said data queue of said decentralized control platform.

12. The control software architecture in accordance with claim 9, wherein said decentralized control platform is provided with position information identifying an ECU in which said control application software is located.

13. The control software architecture in accordance with claim 9, wherein
said condition common data section and said data queue are provided for each one of said control application softwares, and
said data queue includes a request acceptance data queue for receiving said request instruction data from other control application software, and a request issue data queue for issuing said request instruction data to other control application software.

14. The control software architecture in accordance with claim 9, wherein said decentralized control platform is equipped for each one of said control application softwares.

15. A control software architecture for realizing a decentralized cooperative control of a plurality of electronic control apparatuses connected via a network, wherein
each of said electronic control apparatuses comprises:
control application software for realizing each system, said control application software having no time synchronization function;
a decentralized control platform provided commonly for said plurality of electronic control apparatuses, said decentralized control platform having time synchronization function for communications softwares for executing communications between respective systems, between respective control application softwares, and between respective electronic control apparatuses; and
driver software for receiving an actuator drive command instructed from said control application software via said decentralized control platform or/and transmitting data to said decentralized control platform.

16. The control software architecture in accordance with claim 15, wherein said decentralized control platform is provided with position information identifying an ECU in which said control application software is located.

17. The control software architecture in accordance with claim 15, wherein said time synchronization function is for transmitting the data with reference to a transmission timing determined according to a deadline time of the processing in said control application software, thereby realizing optimum time synchronization in each electronic control apparatus.

18. The control software architecture in accordance with claim 15, wherein said decentralized control platform is equipped for each one of said control application softwares.
